(19) United States
(12) Patent Application Publication
(10) Pub. No.: US 2006/0265307 A1
(43) Pub. Date: Nov. 23, 2006

(54) Trader's Hedge

(76) Inventor: James Boyd Walker JR., mirriam,, KS (US)

Correspondence Address: James Boyd Walker, 9000 W. 67th Street, Mission, KS, 66202-3631, US

(21) Appl. No.: 10/906,347

(22) Filed: Feb. 15, 2005

(30) Foreign Application Priority Data
Jan. 24, 2005 (DE) 10 2005 003 225.7

(51) Int. Cl. G06Q 40/00

(52) U.S. Cl. 705/37

(57) ABSTRACT

The process of collecting trades is done every ten minutes by pulling an updated file from the FCM. The file comes in varying formats from the FCM's worked with. Each line of the file represents a fill and it is sent though custom mapping code to convert to a common data structure. With the data in a consistent format, the system sends the symbol through a database conversion differing by FCM. Due to each clearing firm presenting a different code for the same Futures/Options symbol this process is required. Additionally once the symbol is determined one of currently four price format conversions is required. After the format is converted the decimal point must be adjusted to bring the price to its actual decimal form. Trader's Hedge then checks the data in numerous other ways to ensure its accuracy, including, acceptable trading month for the symbol, acceptable price increment for future or option, acceptable price given the day's trading range, valid account number available in the system. Once all checks are passed the fill is entered into the system. This process is repeated with each fill and thusly each FCM registered active in the system.

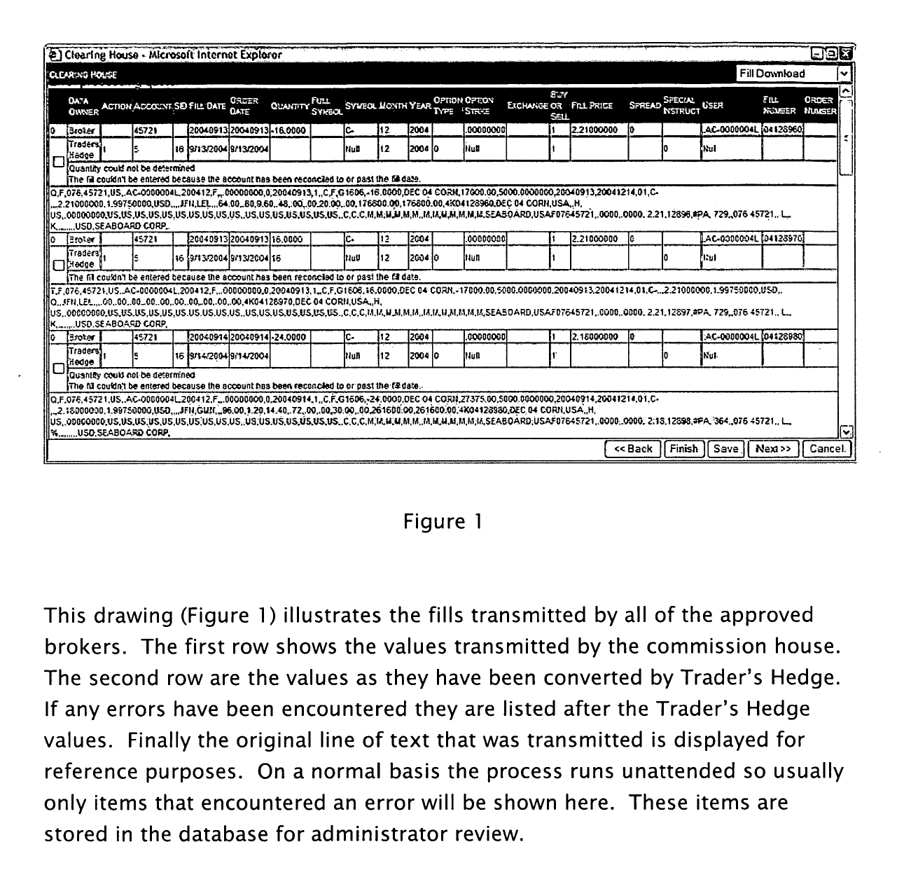

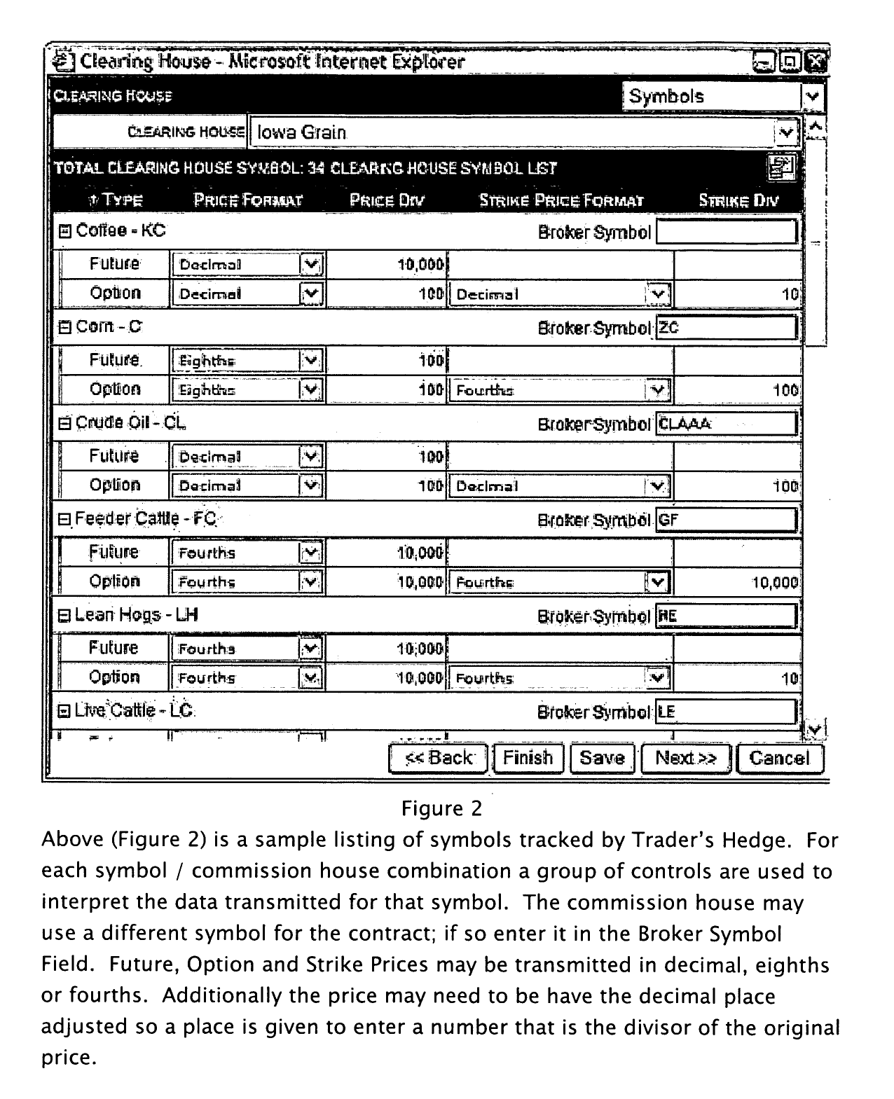

This web-based software combines electronic fills for futures and options from multiple trading firms into a position management tool. The application displays the automatic transmissions into various formats and search criteria set by the user. Ultimately, using these automatically generated electronic transmissions; the user is enabled to see the combinations of positions between trading firms, locations, commodities, and traders.

The process of collecting trades is done every ten minutes by pulling an updated file from the FCM. The file comes in varying formats from the FCM's that have been approved and set up in the system. Each line of the file represents a fill and it is sent though custom mapping code to convert to a common data structure. With the data in a consistent format, the system sends the symbol through a database conversion differing by FCM. Due to each clearing firm presenting a different code for the same Futures/Options symbol this process is required. Additionally once the symbol is determined one of currently four price format conversions is required. After the format is converted the decimal point must be adjusted to bring the price to its actual decimal form. Trader's Hedge then checks the data in numerous other ways to ensure its accuracy, including acceptable trading month for the symbol, acceptable price increment for future or option, acceptable price given the day's trading range, valid account number available in the system. Once all checks are passed the fill is entered into the system. This process is repeated with each fill and thusly each FCM registered active in the system.

What is claimed is:

1. Currently there is not an existing electronic capability to automatically collect trade fills for futures and options from multiple trading firms and have them displayed either real time or delayed into one single application to determine a P&L, project margin calls, perform “what if” analysis, and monitor position limits established to manage financial risk to the user. This software does all this.
